(19) United States
(12) Patent Application Publication
(10) Pub. No.: US 2022/0203986 A1
(43) Pub. Date: Jun. 30, 2022

(54) METHOD FOR DRIVING A MOTOR VEHICLE

(71) Applicants: Renault s.a.s., Boulogne-Billancourt (FR); NISSAN Motor Co., Ltd ., Yokohama-Shi (JP)

(72) Inventors: Renaud DEBORNE, Le Chesnay (FR); Gerald LEMINOUX, Longnes (FR); Denis MALLOL, Rouen (FR)

(73) Assignees: Renault s.a.s., Boulogne-Billancourt (FR); NISSAN Motor Co., Ltd ., Yokohama-Shi (JP)

(21) Appl. No.: 17/639,300

(22) PCT Filed: Sep. 8, 2020
(86) PCT No.: PCT/EP2020/075102

§ 371 Date: Feb. 28, 2022

(30) Foreign Application Priority Data
Sep. 18, 2019 (FR) 1910295

(51) Int. Cl. B60W 30/17; B60W 60/00

(52) U.S. Cl. CPC B60W 30/17; B60W 60/001; B60W 2554/4041; B60W 2720/10; B60W 2554/802; B60W 2520/10; B60W 2554/4042

(57) ABSTRACT

A method for controlling a drive unit of a motor vehicle include acquiring a speed instruction, measuring the speed of the motor vehicle, and computing a control instruction for the drive unit on the basis of the measured speed and of the speed instruction. When the motor vehicle is moving forwards and should be stopped, the speed instruction is determined so as to be strictly less than zero.

### TECHNICAL FIELD OF THE INVENTION

The present invention relates generally to autonomous or semi-autonomous (with driving assist) motor vehicles.

It relates more particularly to a method for controlling a drive member of a motor vehicle, comprising:
a step of acquisition of a speed setpoint,
a step of measurement of the speed of the motor vehicle, and
a step of calculation of a control setpoint for said drive member as a function of the measured speed and of the speed setpoint.

The invention is particularly advantageously applicable in the field of vehicle braking at low speed.

It relates also to a motor vehicle adapted to implement the abovementioned method.

### STATE OF THE ART

Solutions are currently being sought that allow the safety of motor vehicles to be increased when traveling on roads.

These solutions propose either to assist the drivers in driving their vehicles in complete safety, or to drive these vehicles autonomously, without the help of the driver.

One of the technologies employed to this end consists of an adaptive speed regulator, better known by the acronym ACC (from the expression “adaptive cruise control”). According to this technology, when the driver has chosen a speed that he or she would like to travel, the computing unit embedded in the vehicle drives the latter in such a way that it moves forward at this speed as long as there is no known danger and that it modulates this speed when the traffic is dense, so as to maintain a sufficient safe distance with the vehicle preceding it.

This solution is, for example, described in the documents U.S. Pat. Nos. 6,878,096 and 7,117,077.

This solution requires the instantaneous speed of the vehicle equipped with this technology to be accurately known.

Unfortunately, the sensors embedded in the vehicles for measuring this speed are not reliable when the speed is very low (less, for example, than 1 km/h).

There is consequently a risk consisting in considering that the vehicle is stopped when it is still traveling at low speed.

In the document U.S. Pat. No. 6,878,096, provision is then made to extrapolate the stopping of the vehicle by taking account of the changes to its speed, then to activate the parking brake and change the gear ratio (in neutral then park mode) when the vehicle is considered to be stopped.

This solution does not however prove satisfactory, notably because it risks activating the parking brake while the vehicle is still traveling.

### SUMMARY OF THE INVENTION

In order to remedy the abovementioned drawbacks of the state of the art, the present invention proposes aiming not for a zero speed for stopping the vehicle, but a negative speed.

More particularly, according to the invention, a control method is proposed as defined in the introduction, wherein, when the motor vehicle is moving forward and has to be stopped, the speed setpoint is determined so as to be strictly less than zero.

Thus, the invention proposes solving the problem of measurement error at low speed without modifying the vehicle control law, but rather by deceiving this control law.

This invention then has the advantage of ensuring a continuity of the braking control of the vehicle when the vehicle has to be stopped, of not requiring sensors other than those already provided to ensure the adaptive speed regulator function and of ensuring, after the complete stopping of the vehicle, that the stopping thereof will be maintained.

Other advantageous and nonlimiting features of the control method according to the invention, taken individually or according to all technically possible combinations, are as follows:
the motor vehicle is considered to be moving forward and having to be stopped when the speed setpoint passes from a strictly positive value to zero;
the control setpoint is determined as a function at least of the deviation between the speed setpoint and the measured speed;
the control setpoint is determined as a function also of an external datum relating to the environment of the motor vehicle;
a step of acquisition of a desired speed is provided and wherein the speed setpoint is determined as a function of the desired speed;
the speed setpoint is determined as a function of an external datum relating to the environment of the motor vehicle;
another vehicle preceding said motor vehicle, the external datum comprises the speed of said other vehicle and/or the distance separating the two vehicles.

The invention also proposes a motor vehicle equipped with a drive unit programmed to implement the method defined above.

Obviously, the different features, variants and embodiments of the invention can be associated with one another according to various combinations in as much as they are not mutually incompatible or exclusive.

### DETAILED DESCRIPTION OF THE INVENTION

The description given below in light of the attached drawings, given as nonlimiting examples, will give a good understanding of what the invention consists of and how it can be produced.

In the attached drawings:

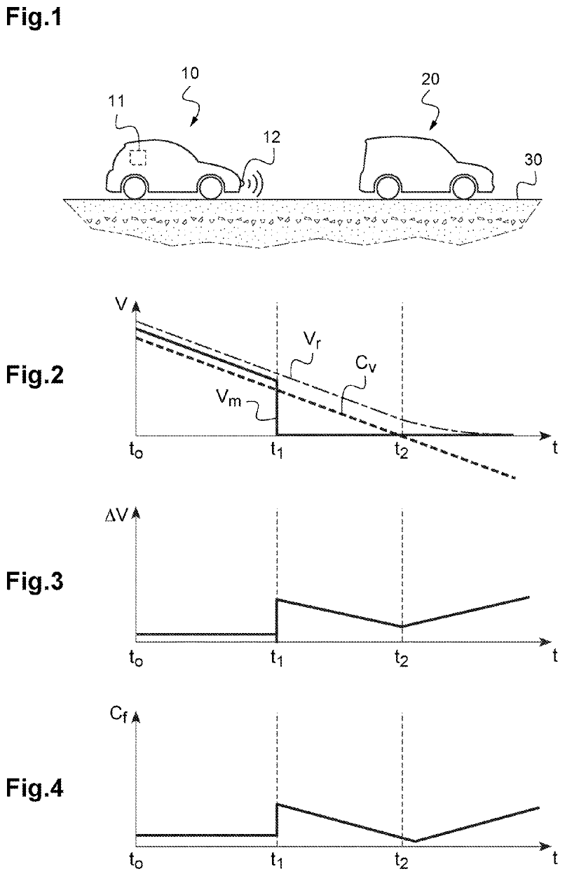

FIG. 1 is a schematic side view of two motor vehicles traveling on a road;

FIG. 2 is a graph illustrating the variation in time of the real speed of one of the vehicles of FIG. 1, of the speed setpoint and of the measured speed;

FIG. 3 is a graph illustrating the variation of a speed error; and

FIG. 4 is a graph illustrating the variation in time of a braking setpoint of the vehicle.

In FIG. 1, two motor vehicles 10, 20 are represented traveling on a road 30.

The motor vehicle that will be considered more particularly here will be the one which is following the other. This motor vehicle will hereinafter be called vehicle considered 10. The other motor vehicle will be called preceding vehicle 20.

As appears in FIG. 1, the vehicle considered 10 is, here, a car comprising a chassis which is supported by wheels and which itself supports various equipment including a power train, braking means, and a steering unit.

It will be able to be a manually-controlled vehicle, in which case the latter will be equipped with driver assistance means, or, preferentially, an autonomous vehicle.

The braking means here comprise four brake stirrups designed to clamp the brake disks with which the four wheels of the vehicle considered 10 are equipped. These braking means further comprise a drive member that, here, takes the form of an actuator suitable for actuating the four brake stirrups when it receives the appropriate setpoint in order to brake the vehicle considered 10.

This vehicle considered 10 is equipped with sensors allowing it to be identified in its environment so as to be able to drive at least the braking means autonomously, that is to say without human intervention.

Any type of sensor could be employed.

In the example represented in FIG. 1, the vehicle considered 10 is equipped with a remote sensor RADAR 12 oriented toward the front of the vehicle in order to determine the distance d₁₀₋₂₀ separating the two motor vehicles 10, 20. This remote sensor RADAR 12 is also here adapted to measure the speed V₂₀ of the preceding vehicle 20.

The vehicle considered 10 could, as a variant, be equipped with a camera or any other telemetry sensor (LIDAR or SONAR).

The vehicle is moreover equipped with a speed sensor suitable for measuring the speed V_{M} with which it is traveling on the road 30. This speed sensor is, for example, suitable for measuring the speed of rotation of the wheels of the vehicle and for deducing therefrom the value of the speed V_{M}.

Finally, the vehicle considered 10 is equipped with a means for inputting a speed at which the driver wants to travel (hereinafter called desired speed V_{S}).

In order to process the information supplied by the input means, by the speed sensor and by the remote detector RADAR 12, and in order to be able to generate a braking setpoint Cf for the vehicle considered 10, the latter is equipped with a drive unit hereinafter called computer 11.

This computer 11 comprises a processor, a memory and various input and output interfaces.

Through its input interfaces, the computer 11 is adapted to receive input signals originating from the input means, from the speed sensor and from the remote detector RADAR 12.

The memory of the computer 11 stores a computer application, consisting of computer programs comprising instructions, the executing of which by the processor allows the computer to implement the method described hereinbelow.

Among these computer programs, one ensures the adaptive speed regulator function.

Finally, through its output interfaces, the computer is adapted to transmit setpoints to the various members of the vehicle, and notably to the braking means.

The method according to the invention is provided to generate a control of the actuator of the braking means which makes it possible to ensure the complete stopping of the vehicle considered 10 when that proves necessary. This method comprises a number of steps implemented recursively, that is to say in a loop, with regular time steps.

It first of all comprises an initialization step during which the computer 11 acquires the measured speed V_{M} of the vehicle considered 10, the speed V₂₀ of the preceding vehicle 20 and the distance d₁₀₋₂₀ separating these two vehicles.

In this step, the computer also acquires the desired speed V_{S}. Here, this speed is input by the driver of the vehicle considered 10. As a variant, provision could be made for it to be determined otherwise (it could for example be chosen to be equal to the legal speed limit on the road being taken).

During a second step, the computer 11 determines whether the adaptive speed regulator function is activated or not.

If it is not, the method is reset and therefore reverts to the initialization step.

If it is, the method continues in a third step during which the computer calculates a speed setpoint Cv for the vehicle considered 10.

This speed setpoint Cv is, here, for example, determined as follows.

As long as no vehicle is preceding the vehicle considered 10 or as long as the distance d₁₀₋₂₀ separating the vehicle considered 10 from the preceding vehicle 20 is greater than a determined safe distance (which depends for example on the measured speeds V_{M}, V₂₀), the speed setpoint Cv is chosen to be equal to the desired speed V_{S}.

When the distance d₁₀₋₂₀ separating the vehicle considered 10 from the preceding vehicle 20 is less than the determined safe distance, the speed setpoint Cv is reduced so as to keep the distance d₁₀₋₂₀ equal to the safe distance.

Then, the method continues in a fourth step during which the computer 11 determines the control setpoint of the actuator of the braking means, hereinafter called braking setpoint Cf.

For that, the computer 11 calculates the deviation ⊗V, in absolute value, between the speed setpoint Cv and the measured speed V_{M}, then it deduces therefrom the braking setpoint Cf using a closed feedback loop. The braking setpoint Cf is therefore, here, determined conventionally as a function of the speed setpoint Cv and of the measured speed V_{M}. It is thus possible for example to use a corrector of PID (proportional, integral, derivative) type.

According to the invention, when the speed setpoint Cv passes from a positive value to a value equal to zero, which can be interpreted as a desire to stop the vehicle considered 10, this speed setpoint Cv is then determined so as to have a negative value.

In this way, the deviation ⊗V becomes once again positive, which allows the computer 11 to calculate a braking setpoint Cf which is not zero.

An example of implementation of this method can be described in more detail with reference to FIGS. 2 to 4. This example corresponds to the possible situation in which the vehicle considered 10 is forced to brake since the preceding vehicle 20 has stopped.

Between the instants t₀ and t₁, the real speed V_{R} of the vehicle considered 10 is high enough for the measurement performed by the speed sensor to be reliable.

It can be seen in FIG. 2 that the speed setpoint Cv decreases progressively so as to control the stopping of the vehicle considered 10. It can also be seen therein that the real speed V_{R} and the measured speed V_{M} decrease also, substantially identically.

It will be noted that there is only a delay between the speed setpoint Cv and the measured speed V_{M}, which is explained by the non-zero response time of the braking chain (transmission, response time of the actuators, etc.).

Between the instants t₀ and t₁, the deviation ⊗V between the speed setpoint Cv and the measured speed V_{M}, represented in FIG. 3, is therefore non-zero, such that the braking setpoint Cf (represented in FIG. 4) is determined so as to be also non-zero.

At the instant t₁, the real speed V_{R} of the vehicle considered 10 becomes too low for the speed sensor to be capable of measuring it accurately. Also, as FIG. 2 shows, the measured speed V_{M} drops suddenly to zero.

At this instant, as FIG. 3 shows, the deviation ⊗V between the speed setpoint Cv and the measured speed V_{M}, represented in FIG. 3, increases abruptly. Then, as FIG. 4 shows, the braking setpoint Cf (represented in FIG. 4) increases, also abruptly (in practice, this increase will be filtered and made gentler by the PID corrector).

Consequently, the real speed V_{R} of the vehicle considered continues to decrease.

When the speed setpoint Cv becomes zero (at the instant t₂), the deviation ⊗V between the speed setpoint Cv and the measured speed V_{M} is also canceled. Then, as FIG. 4 shows, the braking setpoint Cf (represented in FIG. 4) also becomes equal to zero.

The risk is then that the vehicle is not completely stopped, which may not be detected by the speed sensor. In our example, FIG. 2 thus shows that the real speed V_{R} is, at that instant, still positive and non-zero.

To prevent this risk without modifying the abovementioned control law of the adaptive speed regulation function, the speed setpoint Cv is then determined so as to become strictly negative while the vehicle is either stopped or moving forward.

Consequently, the deviation ⊗V between the speed setpoint Cv and the measured speed V_{M}, represented in FIG. 3, increases again. Then, as FIG. 4 shows, the braking setpoint Cf (represented in FIG. 4) also increases again gradually, which ensures the complete stopping of the vehicle and that it is kept in stopped position, as the curve of real speed V_{R} illustrated in FIG. 2 shows.

Provision can then be made to cancel the speed setpoint Cv after a predefined time.

The present invention is in no way limited to the embodiment described and represented, but the person skilled in the art will be able to add any variant that conforms to the invention.

Thus, it would be possible to envisage determining that the motor vehicle is moving forward and has to be stopped in a different way.

Provision could thus be made to calculate a criterion indicating whether or not the vehicle considered has to be stopped as a function of the measured speed V_{M}, of the speed V₂₀ of the preceding vehicle 20 and of the distance d₁₀₋₂₀.

It would thus be possible, if these three data are below three predetermined thresholds, to provide for the motor vehicle to have to be stopped. Consequently, the speed setpoint Cv could be directly set at a strictly negative value.

1-8. (canceled)

9. A method for controlling a drive member of a motor vehicle, comprising:
acquiring a speed setpoint;
measuring a speed of the motor vehicle; and
calculating a control setpoint for said drive member as a function of the measured speed and of the speed setpoint,
wherein, when the motor vehicle is moving forward and has to be stopped, the speed setpoint is determined so as to be strictly less than zero.

10. The control method as claimed in claim 9, wherein the motor vehicle is considered to be moving forward and having to be stopped when the speed setpoint passes from a strictly positive value to zero.

11. The control method as claimed in claim 9, wherein the control setpoint is determined as a function at least of a deviation between the speed setpoint and the measured speed.

12. The control method as claimed in claim 9, wherein the control setpoint is determined as a function also of an external datum relating to an environment of the motor vehicle.

13. The control method as claimed in claim 12, wherein, when another vehicle precedes said motor vehicle, the external datum comprises at least one of a speed of said other vehicle and a distance separating said other vehicle and said motor vehicle.

14. The control method as claimed in claim 9, further comprising acquiring a desired speed,
wherein the speed setpoint is determined as a function of the desired speed.

15. The control method as claimed in claim 9, wherein the speed setpoint is determined as a function of an external datum relating to an environment of the motor vehicle.

16. The control method as claimed in claim 15, wherein, when another vehicle precedes said motor vehicle, the external datum comprises at least one of a speed of said other vehicle and a distance separating said other vehicle and said motor vehicle.

17. A motor vehicle, comprising:
an autonomous or assisted drive unit, wherein the drive unit is programmed to implement the control method as claimed in claim 9.
